(19) United States
(12) Patent Application Publication
(10) Pub. No.: US 2010/0097966 A1
(43) Pub. Date: Apr. 22, 2010

(54) CONCURRENT DUAL-BAND RECEIVER AND COMMUNICATION DEVICE HAVING SAME

(75) Inventor: GUO-JHANG CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/432,782

(22) Filed: Apr. 30, 2009

(30) Foreign Application Priority Data
Oct. 17, 2008 (CN) 200810304979.6

(51) Int. Cl. H04L 5/00

(52) U.S. Cl. 370/297

(57) ABSTRACT

A concurrent dual-band receiver includes a front-end subsystem and a concurrent dual-band down-converter. The front-end subsystem supplies radio frequency signals in a first frequency band and a second frequency band. The concurrent dual-band down-converter includes a dual-band frequency synthesizer, a first down-converting circuit, and a second down-converting circuit. The dual-band frequency synthesizer simultaneously generates first local oscillation signals having a first local oscillation frequency and second local oscillation signals having a second local oscillation frequency. The first down-converting circuit mixes the radio frequency signals with the first local oscillation signals to down-convert the radio frequency signals to base band signals, and outputs the down-converted signals from the first frequency band. The second down-converting circuit mixes the radio frequency signals with the second local oscillation signals to down-convert the radio frequency signals to base band signals, and outputs the down-converted signals from the second frequency band.

### BACKGROUND

1. Technical Field

The disclosure relates to radio frequency receivers, and particularly to a concurrent dual-band receiver that can operate in two frequency bands simultaneously and a communication device having the same.

2. Description of Related Art

Wireless communication systems have exhibited remarkable growth over the past decade. A lot of wireless communication networks, such as GSM, CDMA, WCDMA, and PHS, which transmit signals by radio waves with different radio frequency (RF) bands, have been designed to avoid the interference between the signals. Most communication devices generally have receivers which can receive only one band, i.e., many conventional communication devices can only receive signals from only one network. To increase the functionality of the communication devices, dual-band receivers have been introduced. Current dual-band receivers can switch between bands. However, they still cannot receive signals from two bands simultaneously.

Therefore, it is desirable to provide a concurrent dual-band receiver and a communication device which can overcome the described limitations.

### BRIEF DESCRIPTION OF THE DRAWINGS

FIG. 1 is a schematic view of a concurrent dual-band receiver in accordance with an embodiment of the disclosure.

FIGS. 2 and 3 are graphical outputs correspondingly showing the down-conversion of the signals in the first down-converting circuit and the second down-converting circuit of the concurrent dual-band receiver shown in FIG. 1.

FIG. 4 is a block diagram of a communication device having the concurrent dual-band receiver shown in FIG. 1.

### DETAILED DESCRIPTION

Embodiments of the disclosure will now be described in detail with reference to the drawings.

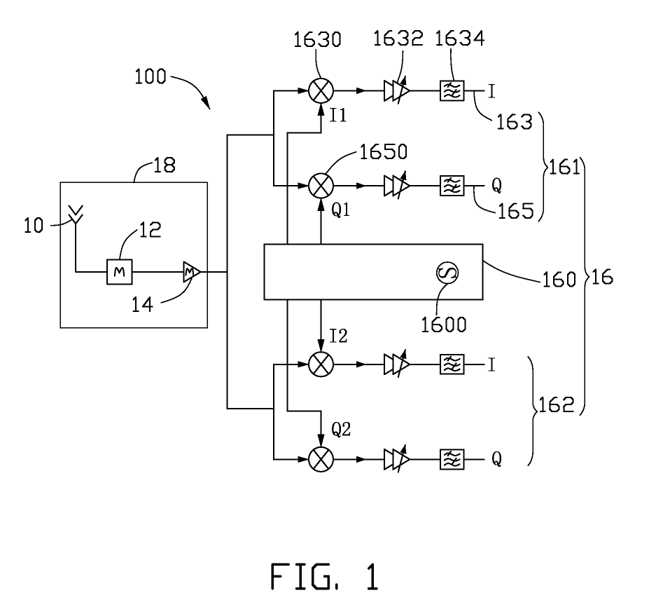

Referring to FIG. 1, a concurrent dual-band receiver 100, according to an exemplary embodiment, includes a dual-band antenna 10, a dual-band filter 12, a dual-band low noise amplifier (LNA) 14, and a concurrent dual-band down-converter 16 connected in series. The dual-band antenna 10, the dual-band filter 12, and the dual-band LNA 14 constitute a front-end system 18.

The dual-band antenna 10 is configured for receiving RF signals from a first frequency band and a second frequency band outside of the first frequency band. For instance, a first frequency channel having a frequency f_{L} in the first frequency band and a second frequency channel having a frequency f_{H} in the second frequency band are received. The frequency f_{L} satisfies condition 1: 0<f₁≦f_{L}≦f₂, and the frequency f_{H} satisfies condition 2: f₂<f₃≦f_{H}≦f₄, where f₁, f₂, f₃, and f₄ are specific frequency values. The gap between the two frequency channels is wider than the two frequency channels, i.e., f₃−f₂>f₂−f₁, f₃−f₂>f₄−f₃ (condition 3).

The dual-band filter 12 is configured for filtering out the RF signals beyond the two frequency bands.

The dual-band LNA 14 is configured for amplifying the RF signals outputted by the dual-band filter 12, and outputting the amplified RF signals to the concurrent dual-band down-converter 16.

The concurrent dual-band down-converter 16 is configured for simultaneously down-converting the RF signals from the two frequency bands to base band signals. The concurrent dual-band down-converter 16 includes a dual-band frequency synthesizer 160, a first down-converting circuit 161 and a second down-converting circuit 162. The first and second down-converting circuits 161, 162 are both connected to the dual-band frequency synthesizer 160 and the dual-band LNA 14.

The dual-band frequency synthesizer 160 includes a dual-band voltage controlled oscillator (VCO) 1600, which is controlled by a circuit (not shown) to generate first local oscillation signals having a first local oscillation frequency f_{O1} and second local oscillation signals having a second local oscillation frequency f_{O2}, where f_{O1} and f_{O2} satisfy condition 4: f₁≦f_{O1}≦f₂<f₃≦f_{O2}≦f₄. In the present embodiment,

f_{O1}=(f₁+f₂)/2,

f_{O2}=(f₃+f₄)/2.

In this embodiment, phase lock loops (PLL) are applied to the dual-band frequency synthesizer 160 to ensure proper local oscillation frequencies. The first local oscillation signals include a first in-phase signal I₁ and a first quardrature signal Q₁ with the first local oscillation frequency f_{O1}. The second local oscillation signals include a second in-phase signal I₂ and a second quardrature signal Q₂ with the second local oscillation frequency f_{O2}. The dual-band frequency synthesizer 160 outputs the first in-phase signal I₁ and the first quardrature signal Q₁ to the first down-converting circuit 161, and outputs the second in-phase signal I₂ and the second quardrature signal Q₂ to the second down-converting circuit 162.

The first down-converting circuit 161 includes an in-phase channel 163 configured for transmitting in-phase signals, and a quardrature channel 165 configured for transmitting quardrature signals.

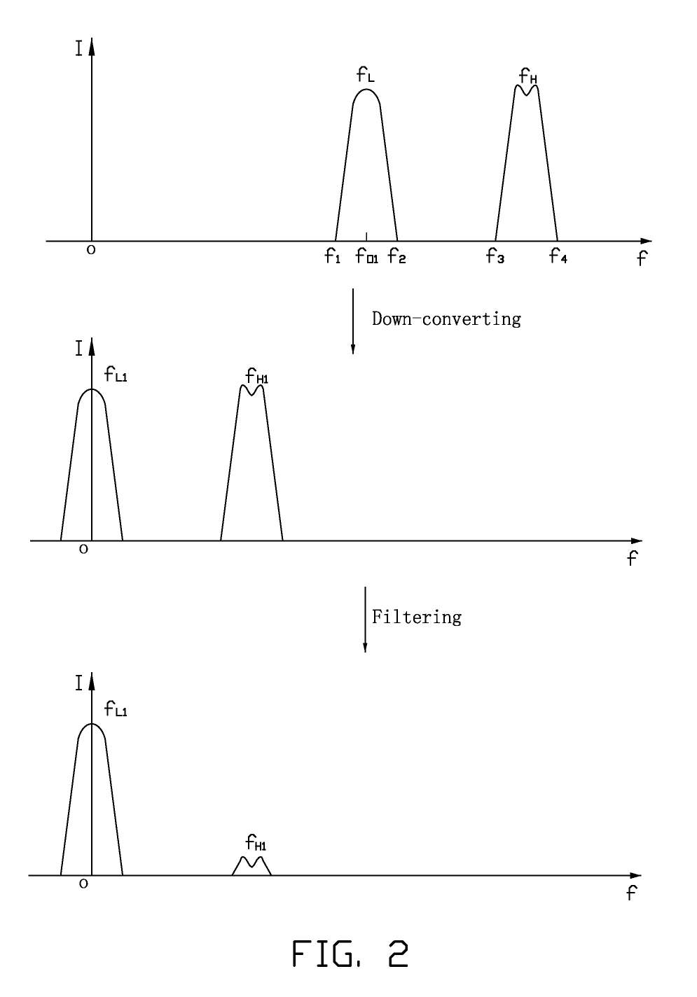

The in-phase channel 163 includes a mixer 1630, a variable gain amplifier (VGA) 1632, and a low pass filter (LPF) 1634 connected in series. The mixer 1630 receives the RF signals of the two frequency channels from the dual-band LNA 14 and the first in-phase signal I₁ from the dual-band frequency synthesizer 160. As shown in FIG. 2, the RF signals of the two frequency channels are mixed in the mixer 1630 with the first in-phase signal I₁, and their frequencies are down-converted according to the following formula:

f_{L1}=|f_{L}−f_{O1}| (1),

f_{H1}=|f_{H}−f_{O1}| (2),

where f_{L1} and f_{H1} are down-converted frequencies of the first frequency channel and the second frequency channel correspondingly. Combining formula (1), (2) and condition 3, it can be concluded that f_{L1}<f_{H1}. The mixer 1630 also demodulates the RF signals into in-phase signals according the first in-phase signal I₁. The VGA 1632 amplifies the signals outputted by the mixer 1630. The LPF 1634 passes the signals having frequency f_{L1} but blocks the signals having frequency f_{H1}, i.e., f_{L1} is in the pass-band of the LPF 1634, while f_{H1} is in the stop-band. In the embodiment, the LPF 1634 has relatively sharp cutoff characteristics such that the signals from the VGA 1632 are properly filtered. Finally, the in-phase channel 163 outputs an in-phase signal with frequency f_{L1}.

The quardrature channel 165 is connected in parallel to the in-phase channel 163, and has the same structure as the in-phase channel 163. Similarly, the quardrature channel 165 receives the RF signals of the two frequency channels from the dual-band LNA 14 and the first quardrature signal Q₁ from the dual-band frequency synthesizer 160, and finally outputs a quardrature signal with frequency f_{L1}.

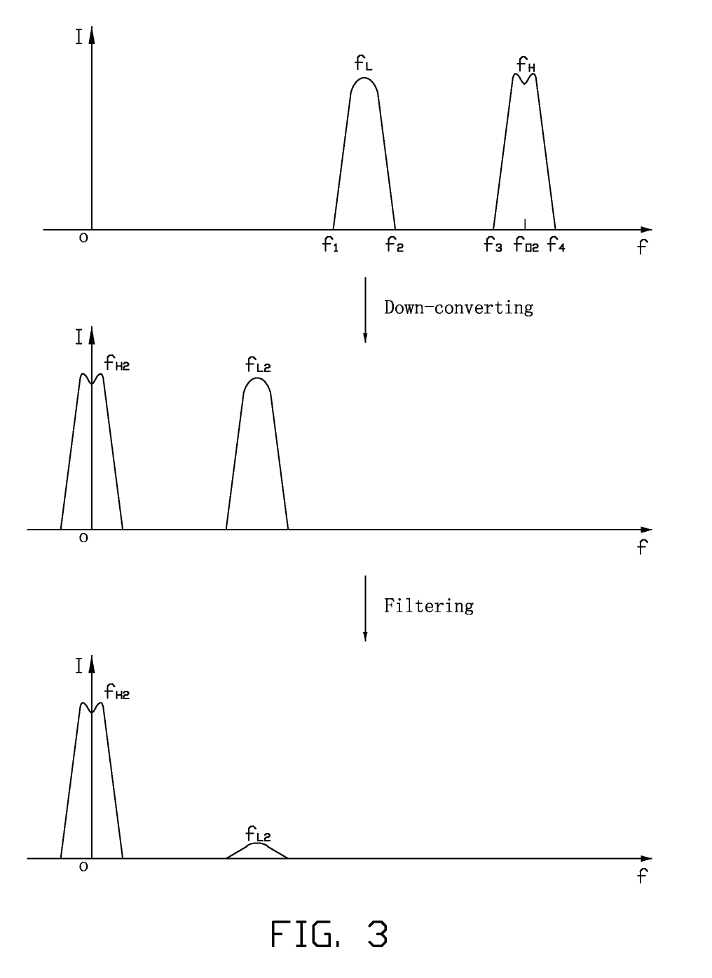

The second down-converting circuit 162 is connected in parallel to the first down-converting circuit 161, and has the same structure as the first down-converting circuit 161. The second down-converting circuit 162 receives the RF signals of the two frequency channels from the dual-band LNA 14, and the second in-phase signal I₂ and the second quardrature signal Q₂ from the dual-band frequency synthesizer 160. As shown in FIG. 3, the RF signals of the two frequency channels are mixed with the second in-phase signal I₂ or the second quardrature signal Q₂, and their frequencies are down-converted according to the following formula:

f_{L2}=|f_{L}−f_{O2}| (3),

f_{H2}=|f_{H}−f_{O2}| (4),

where f_{L2} and f_{H2} are down-converted frequencies of the first frequency channel and the second frequency channel correspondingly. Combining formula (3), (4) and condition 3, it can be concluded that f_{H2}<f_{L2}. Finally, the second down-converting circuit 162 outputs an in-phase signal and a quardrature signal with frequency f_{H2}.

In the embodiment, the RF signals of the first frequency channel and the second frequency channel are simultaneously down-converted and then correspondingly outputted by the first down-converting circuit 161 and the second down-converting circuit 162.

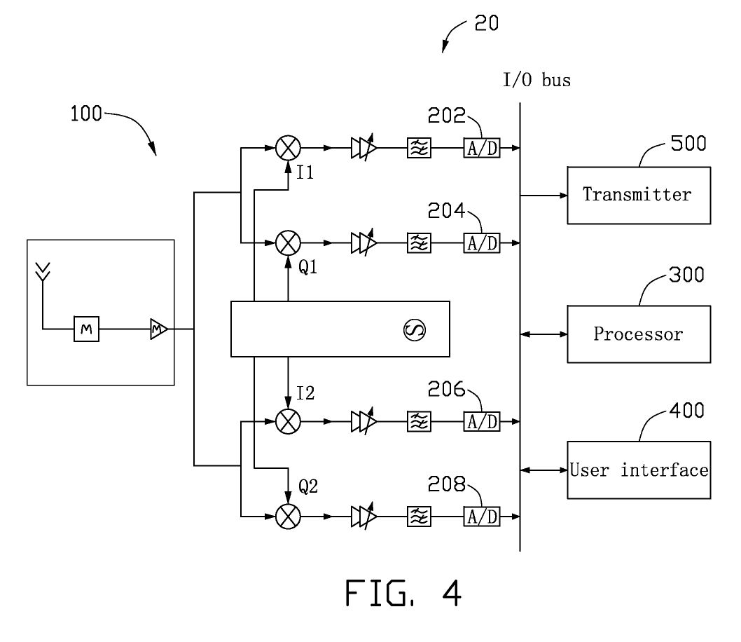

An embodiment of a communication device 20 having the concurrent dual-band receiver 100 is shown in FIG. 4. In the embodiment, the communication device 20 is a mobile phone. The communication device 20 further includes four analog-to-digital (A/D) converters 202, 204, 206, and 208, a processor 300, a user interface 400 and a radio frequency transmitter 500.

The four A/D converters 202, 204, 206, and 208 are correspondingly connected to the in-phase channels and quardrature channels of the concurrent dual-band down-converter 16, and convert the signals outputted by the concurrent dual-band down-converter 16 to digital signals.

The processor 300 is connected to the four A/D converters 202, 204, 206, and 208, and processes the converted digital signals. The processor 300 either simultaneously outputs the processed signals of the two frequency channels to the user interface 400, or optionally outputs the signals of one of the two frequency channels in response to the selection of the user. The processor 300 also processes the signals inputted from the user interface 400, and then outputs to the transmitter 500.

The user interface 400 converts the signals from the processor 300 to visible or audible information. The user interface 400 also inputs electrical signals to the processor 300 in response to the operations of the user. In the embodiment, the user interface 400 includes a display, a keyboard, a microphone and a speaker.

The transmitter 500 converts the signals from the processor 300 to radio waves to communicate with a communication base station.

In summary, the concurrent dual-band receiver 100 and the communication device 20 can simultaneously down-convert and separately output the RF signals of the two frequency channels, so as to use two communication networks in a communication device at a time.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A concurrent dual-band receiver, comprising:
a front-end subsystem configured for supplying radio frequency signals in a first frequency band and a second frequency band outside of the first frequency band; and
a concurrent dual-band down-converter connected to the front-end subsystem and configured for simultaneously down-converting the radio frequency signals supplied by the front-end subsystem, comprising:
a dual-band frequency synthesizer configured for simultaneously generating first local oscillation signals having a first local oscillation frequency and second local oscillation signals having a second local oscillation frequency higher than the first local oscillation frequency;
a first down-converting circuit connected to the front-end subsystem and the dual-band frequency synthesizer, the first down-converting circuit being configured for receiving the first local oscillation signals and the radio frequency signals supplied by the front-end subsystem, mixing the radio frequency signals with the first local oscillation signals to down-convert the radio frequency signals to base band signals, and passing the down-converted signals from the first frequency band but blocking the down-converted signals from the second frequency band; and
a second down-converting circuit connected to the front-end subsystem and the dual-band frequency synthesizer, the second down-converting circuit being connected in parallel to the first down-converting circuit and configured for receiving the second local oscillation signals and the radio frequency signals supplied by the front-end subsystem, mixing the radio frequency signals with the second local oscillation signals to down-convert the radio frequency signals to base band signals, and passing the down-converted signals from the second frequency band but blocking the down-converted signals from the first frequency band.

2. The concurrent dual-band receiver of claim 1, wherein the first local oscillation signals comprise a first in-phase signal and a first quardrature signal, and the second local oscillation signals comprise a second in-phase signal and a second quardrature signal; the first and second down-converting circuits both comprising an in-phase channel and a quardrature channel parallel to the in-phase channel; the in-phase channel and the quardrature channel of the first down-converting circuit being configured for receiving the first in-phase signal and the first quardrature signal correspondingly; the in-phase channel and the quardrature channel of the second down-converting circuit being configured for receiving the second in-phase signal and the second quardrature signal correspondingly.

3. The concurrent dual-band receiver of claim 2, wherein the in-phase channel and the quardrature channel each comprises in series:
a mixer configured for mixing the radio frequency signals with the local oscillation signals to down-convert the radio frequency signals to base band signals;
a variable gain amplifier configured for amplifying the signals outputted by the mixer; and
a low pass filter configured for filtering out the down-converted signals from the first or second frequency band.

4. The concurrent dual-band receiver of claim 1, wherein the dual-band frequency synthesizer comprises a dual-band voltage controlled oscillator configured for simultaneously generating the first local oscillation signals and the second local oscillation signals.

5. The concurrent dual-band receiver of claim 1, wherein the front-end subsystem comprises in series:
a dual-band antenna configured for receiving radio frequency signals from the first and second frequency bands;
a dual-band filter configured for filtering out the radio frequency signals beyond the first and second frequency bands; and
a dual-band low noise amplifier configured for amplifying the radio frequency signals outputted by the dual-band filter.

6. A communication device comprising a concurrent dual-band receiver, a processor, a user interface and a radio frequency transmitter, wherein the concurrent dual-band receiver comprises:
a front-end subsystem configured for supplying radio frequency signals in a first frequency band and a second frequency band outside of the first frequency band; and
a concurrent dual-band down-converter connected to the front-end subsystem and configured for simultaneously down-converting the radio frequency signals supplied by the front-end subsystem, comprising:
a dual-band frequency synthesizer configured for simultaneously generating first local oscillation signals having a first local oscillation frequency and second local oscillation signals having a second local oscillation frequency higher than the first local oscillation frequency;
a first down-converting circuit connected to the front-end subsystem and the dual-band frequency synthesizer, the first down-converting circuit being configured for receiving the first local oscillation signals and the radio frequency signals supplied by the front-end subsystem, mixing the radio frequency signals with the first local oscillation signals to down-convert the radio frequency signals to base band signals, and passing the down-converted signals from the first frequency band but blocking the down-converted signals from the second frequency band; and
a second down-converting circuit connected to the front-end subsystem and the dual-band frequency synthesizer, the second down-converting circuit being parallel to the first down-converting circuit and configured for receiving the second local oscillation signals and the radio frequency signals supplied by the front-end subsystem, mixing the radio frequency signals with the second local oscillation signals to down-convert the radio frequency signals to base band signals, and passing the down-converted signals from the second frequency band but blocking the down-converted signals from the first frequency band.

7. The communication device of claim 6, wherein,
the processor is connected to the concurrent dual-band down-converter and configured for processing the down-converted signals outputted by the first and second down-converting circuits;
the user interface is configured for converting the signals processed by the processor to visible or audible information, and inputting electrical signals to the processor in response to the operations of the user; and
the transmitter is configured for converting the signals outputted from the processor to radio waves to communicate with a communication base station.

8. The communication device of claim 6, further comprising:
a plurality of analog-to-digital converters interconnected the processor and the concurrent dual-band down-converter and configured for converting the signals outputted by the concurrent dual-band down-converter to digital signals.

9. The communication device of claim 6, wherein the processor outputs the signals from at least one of the first and second frequency band to the user interface.

10. The communication device of claim 6, wherein the first local oscillation signals comprise a first in-phase signal and a first quardrature signal, and the second local oscillation signals comprise a second in-phase signal and a second quardrature signal; the first and second down-converting circuits both comprising an in-phase channel and a quardrature channel parallel to the in-phase channel; the in-phase channel and the quardrature channel of the first down-converting circuit being configured for receiving the first in-phase signal and the first quardrature signal correspondingly; the in-phase channel and the quardrature channel of the second down-converting circuit being configured for receiving the second in-phase signal and the second quardrature signal correspondingly.

11. The communication device of claim 10, wherein the in-phase channel and the quardrature channel each comprises in series:
a mixer configured for mixing the radio frequency signals with the local oscillation signals to down-convert the radio frequency signals to base band signals;
a variable gain amplifier configured for amplifying the signals outputted by the mixer; and
a low pass filter configured for filtering out the down-converted signals from the first or second frequency band.

12. The communication device of claim 6, wherein the dual-band frequency synthesizer comprises a dual-band voltage controlled oscillator configured for simultaneously generating the first local oscillation signals and the second local oscillation signals.

13. The communication device of claim 6, wherein the front-end subsystem comprises in series:
a dual-band antenna configured for receiving radio frequency signals from the first and second frequency bands;
a dual-band filter configured for filtering out the radio frequency signals beyond the first and second frequency bands; and
a dual-band low noise amplifier configured for amplifying the radio frequency signals outputted by the dual-band filter.
